(19) United States
(12) Patent Application Publication
(10) Pub. No.: US 2006/0210237 A1
(43) Pub. Date: Sep. 21, 2006

(54) Electronic function part mounted body and method of manufacturing the electronic function part mounted body

(76) Inventor: Kaoru Soeta, Tokyo (JP)

Correspondence Address: BRINKS HOFER GILSON & LIONE, P.O. BOX 10395, CHICAGO, IL, 60610, US

(21) Appl. No.: 11/384,046

(22) Filed: Mar. 17, 2006

(30) Foreign Application Priority Data
Mar. 18, 2005 (JP) 2005-079874

(51) Int. Cl. G02B 6/00

(52) U.S. Cl. 385/147

(57) ABSTRACT

A spiral contactor is provided on a substrate. An electronic function part and the substrate are adhered with an anisotropic conductive paste while an electrode portion of the electronic function part is being contacted with the spiral contactor. Thus, the electronic function part and the substrate can be securely fixed together while an adequate electrical connection between the electrode portion of the electronic function part and the spiral contactor is ensured.

### BACKGROUND OF THE INVENTION

1. Field of the Invention

The present invention relates to an electronic function part mounted body in which an electronic function part such as a bare chip is mounted on a substrate, and a method of manufacturing the electronic function part mounted body.

2. Description of the Related Art

An electronic part which uses a spiral contactor is disclosed in U.S. Pat. No. 6,517,362 (see FIG. 23 and FIG. 24, from column 13, line 60 to column 14, line 22).

In U.S. Pat. No. 6,517,362, an electronic part in which a printed wiring board and a spiral contactor provided on a connector cable are connected together is disclosed.

However, in U.S. Pat. No. 6,517,362, there is no specific description of how to fix and hold the printed wiring board and the connector cable. It is required to adequately ensure an electrical connection between the spiral contactor and an electrode portion (in U.S. Pat. No. 6,517,362, referred to as a metal ball) of the printed wiring board while the printed wiring board and the connector cable are fixed and held. Also, the printed wiring board and the connector cable should be tightly fixed together.

For example, if a fixing and holding member is provided separately from the printed wiring board or connector cable, the electronic function part will be increased in size which is not preferable.

### SUMMARY OF THE INVENTION

Accordingly, the present invention has been made to solve the above-mentioned problems, and it is an object of the present invention to provide an electronic function part mounted body capable of securely fixing an electronic function part and a substrate while ensuring an electrical connection between the electronic function part and the substrate.

Further, it is another object of the present invention to provide a method of manufacturing the electronic function part mounted body.

In order to achieve the above-mentioned objects, the present invention provides an electronic function part mounted body having an electronic function part, and a substrate for mounting the electronic function part. An electrode portion is provided on the surface of the electronic function part opposite to the substrate and an elastic contact point is provided on the surface of the substrate opposite to the electronic function part. The electronic function part and the substrate are adhered with a conductive or nonconductive adhesive and fixed together while the electrode portion and the elastic contact point are in contact with each other.

In the present invention, the elastic contact point is provided on the opposite surface of the substrate, the electronic function part and the substrate are adhered with the conductive or nonconductive adhesive and fixed together while the electrode portion of the electronic function part is being connected to the elastic contact point. Thus, while the electrode portion of the electronic function part maintains a good electrical connection to the elastic contact point, the electronic function part and the substrate can be securely fixed together. Particularly, in the present invention, since a member for fixing and holding the substrate and the electronic function part or the like is not provided at the both sides of the substrate and the electronic function part, the structure of mounting the electronic function part is not complicated and it is possible to decrease the electronic function part mounted body. Further, in the present invention, since it is possible to provide an electrical connection to the electrode portion with elastic deformation of the elastic contact portion, a reliable electrical connection can be ensured, and also an impact-resistant electronic function assembling body can be manufactured.

In the present invention, it is preferable that at least the electrode portion and the elastic contact point are adhered with an anisotropic conductive paste and fixed together. Further, it is preferable that the substrate includes a base and a contact member having the elastic contact point and a sheet member, the contact member is connected to the base, a through hole is formed in the sheet member, the elastic contact point is exposed from the through hole, the through hole is filled with the anisotropic conductive paste, and the electrode portion and the elastic contact point are adhered and fixed together. By the structure, the electronic function part and the substrate can be fixed together while an electrical connection between the electrode portion and the elastic contact point is ensued. Particularly, in the structure that the inside of the through hole provided in the sheet member is filed with the anisotropic conductive paste, an adequate amount of the anisotropic conductive paste is placed between the electrode portion and the elastic contact point. Thus, even if the adhesive is partially applied, it is possible to adequately adhere the substrate and the electronic function part and fix them together.

Further, in the present invention, it is possible to provide a structure in which the entire area of the opposite surface of the electronic function part is adhered onto the opposite surface of the substrate with the anisotropic conductive paste and fixed. By the structure, further ensured adhesion and fixation of the substrate and the electronic function part can be achieved.

Further, in the present invention, it is preferable that at least a part of the opposite surface of the electronic function part and the opposite surface of the substrate except for an area where the electrode portion and the elastic contact point are to be formed is adhered with a nonconductive paste and fixed. By providing the nonconductive paste between the opposite surface of the electronic function part and the opposite surface of the substrate except for an area where the electrode portion and the elastic contact point are to be formed, while adequately electrically connecting the electrode portion of the electronic function part with the elastic contact point, the electronic function part and the substrate can be securely adhered and fixed together.

Further, in the present invention, at least a part of the opposite surface of the electronic function part and the opposite surface of the substrate except for an area where the electrode portion and the elastic contact point are to be formed may be adhered with a nonconductive film and fixed.

Further, in the present invention, it is preferable that the substrate includes a base and a contact member having the elastic contact point and a sheet member, the contact member is connected to the base, a through hole is formed in the sheet member, the elastic contact point is exposed from the through hole, and the nonconductive paste or the nonconductive film is provided between the sheet member except for the area where the through hole is to be formed and the opposite surface of the electronic function part. By the structure, the electronic function part and the substrate can be securely adhered and fixed together.

Further, in the present invention, it is preferable that the elastic contact point comprises a spiral contactor.

Further, in the present invention, in a method of manufacturing an electronic function part mounted body, the electronic function part mounted body has an electronic function part and a substrate for mounting the electronic function part, an electrode portion is provided on the surface of the electronic function part opposite to the substrate and an elastic contact point is provided on the surface of the substrate opposite to the electronic function part, the electronic function part and the substrate are adhered with an conductive or nonconductive adhesive and fixed together while the electrode portion and the elastic contact point are in contact with each other. By the method, the electronic function part and the substrate are securely adhered and fixed together while the electrode portion of the electronic function part and the elastic contact point maintain a good electrical connection with each other.

Further, in the present invention, it is preferable that at least the electrode portion and the elastic contact point are adhered with an anisotropic conductive paste and fixed together. Further, it is preferable that the substrate includes a base and a contact member having the elastic contact point and a sheet member, the contact member is connected to the base, a through hole is formed in the sheet member, the elastic contact point is exposed from the through hole, filling the anisotropic conductive paste into the through hole, and the electrode portion and the elastic contact point are adhered and fixed together. By the method, while an electrical connection between the electrode portion and the elastic contact point is ensured, the electronic function part and the substrate can be adhered and fixed together. Particularly, in the structure that the inside of the through hole provided in the sheet member is filled with the anisotropic conductive paste, and an adequate amount of the anisotropic conductive paste is placed between the electrode portion and the elastic contact point. Therefore, even if the adhesive is partially applied, it can be possible to adequately adhere the substrate and the electronic function part and fix them together.

Further, in the present invention, it is preferable that the entire area of the opposite surface of the electronic function part onto the opposite surface of the substrate with the anisotropic conductive paste are adhered and fixed together since the electronic function part and the substrate can be adhered and fixed together readily and securely.

Further, in the present invention, it is preferable that at least a part of the opposite surface of the electronic function part and the opposite surface of the substrate except for the area where the electrode portion and the elastic contact point are to be formed are adhered with the nonconductive paste and fixed together. Further, it is also preferable that at least a part of the opposite surface of the electronic function part and the opposite surface of the substrate except for the area where the electrode portion and the elastic contact point are to be formed are adhered with the nonconductive film and fixed together. By the method, the electronic function part and the substrate are securely adhered and fixed together while the electrode portion of the electronic function part and the elastic contact point are in good electrical connection with each other.

Further, in the present invention, it is preferable that the substrate includes a base and a contact member having the elastic contact point and a sheet member, the contact member is connected to the base, a through hole is formed in the sheet member, and the elastic contact point is exposed from the through hole, the nonconductive paste or nonconductive film is provided between the sheet member except for an area where the through hole is to be formed and the opposite surface of the electronic function part, are adhered and fixed together. By the method, the adhesion between the electronic function part and the substrate can be enhanced.

Further, in the present invention, it is preferable to place the conductive or nonconductive adhesive between the electronic function part and the substrate, conduct an inspection with the electrode portion and the elastic contact point are being contacted with each other, after the inspection is completed, cure the adhesive by heating, adhere the electronic function part and the substrate, and fix them together. By the method, depending on the result of the inspection, it can be possible to decide whether completely the electronic function part and the substrate are completely adhered and fixed together by heating. Therefore, productivity can be improved.

That is, if performing the heating only when the result of the inspection is acceptable, then, it is not necessary to perform the heating process if the result of the inspection is determined to have failed. Thus, it is possible to increase productivity.

Further, in the present invention, it is possible to conduct an inspection without placing the conductive or nonconductive adhesive between the electronic function part and the substrate, with the electrode portion and the elastic contact point are in contact with each other, after the inspection is completed, place the conductive or nonconductive adhesive between the electronic function part and the substrate, cure the adhesive by heating, adhere the electronic function part and the substrate, and fix them together. In this case, it is preferable that if the result of the inspection is acceptable, the conductive or nonconductive adhesive is placed between the electronic function part and the substrate, and the heating is performed.

Further, in the present invention, it is preferable to replace the electronic function part or the substrate which is determined to have failed by the inspection with a new electronic function part or substrate, and conduct the inspection again. For example, if the inspection is conducted after the substrate and the electronic function part are heated, adhered, and fixed together, and if the result of the inspection is determined to have failed, the electronic function part mounted body has to be discarded even if the substrate is normal. However, by conducting the inspection before the heating process, if the result of the inspection is determined to have failed, only the defective electronic function part or the substrate is replaced and the inspection is conducted again. Thus, it can be possible to reduce waste and increase productivity.

### BRIEF DESCRIPTION OF THE DRAWINGS

FIG. 1 is a perspective view of an electronic module (electronic function part mounted body) according to an first embodiment of the present invention;

FIG. 2 is a partially sectional view of the electronic module taken along the line II-II shown in FIG. 1 in a direction parallel to the Z direction (thickness direction) and viewed from the direction indicated by arrows;

FIG. 3 is a partially enlarged cross-sectional view of the electronic module showing an enlargement of the circled B region in FIG. 2;

FIG. 4 is a partially enlarged cross-sectional view of an electronic module for explaining a structure different from the structure shown in FIG. 3;

FIG. 5 is a partially enlarged cross-sectional view of an electronic module for explaining a structure different from the structure shown in FIG. 3 or 4;

FIG. 6 is a partial plan view showing a surface of a substrate for particularly explaining an adhesion region according to the embodiment of FIG. 3;

FIG. 7 is a partial plan view showing a surface of a substrate for particularly explaining an adhesion region according to the embodiment of FIG. 4;

FIG. 8 is a partial plan view showing a surface of a substrate for particularly explaining an adhesion region according to the embodiment of FIG. 5;

FIG. 9 is a partial plan view showing a surface of a substrate for explaining an embodiment different from that shown in FIG. 6 or FIG. 8;

FIG. 10 is a perspective view showing a multi-tip module (electronic function part mounted body) according to a second embodiment of the present invention;

FIG. 11 is a partial plan view showing a surface of the substrate which appears under the electronic function part according to the embodiment of FIG. 10;

FIG. 12 is a partially sectional view of the multi-tip module taken along the line XII-XII shown in FIG. 10 in a direction parallel to the Z direction (thickness direction) and viewed from the direction indicated by arrows;

FIG. 13 is an enlarged side view for particularly explaining the overall structure of a spiral contactor; and

FIG. 14 is a perspective view for explaining a manufacturing method of the electronic module shown in FIG. 1 by showing each decomposed structure member which composes the electronic module.

### DESCRIPTION OF THE PREFERRED EMBODIMENTS

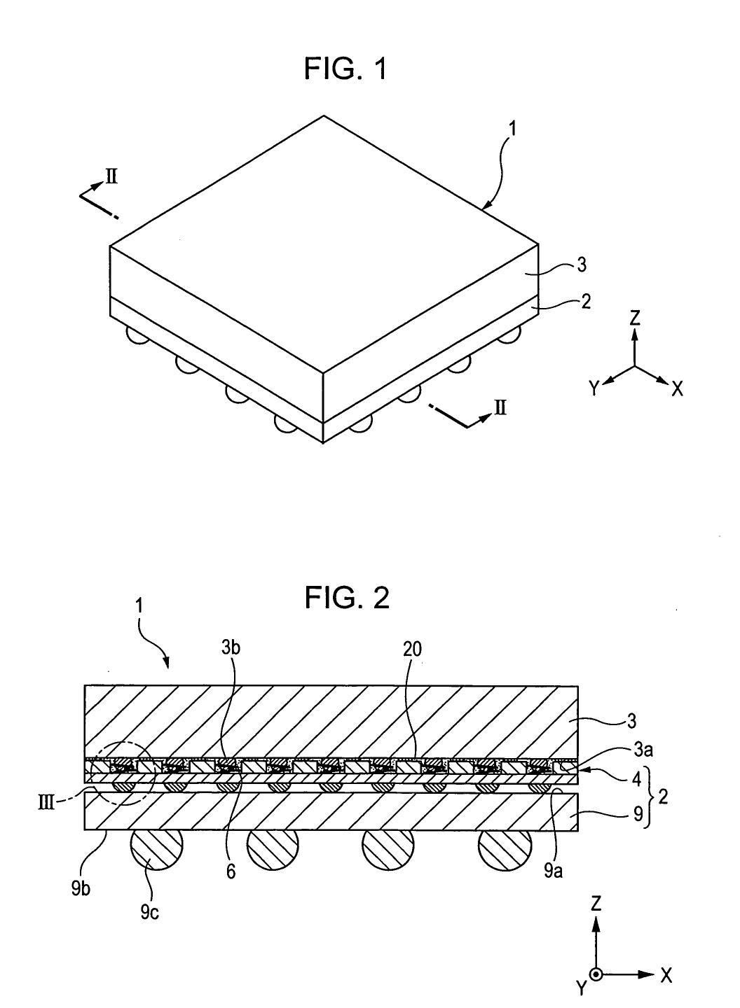

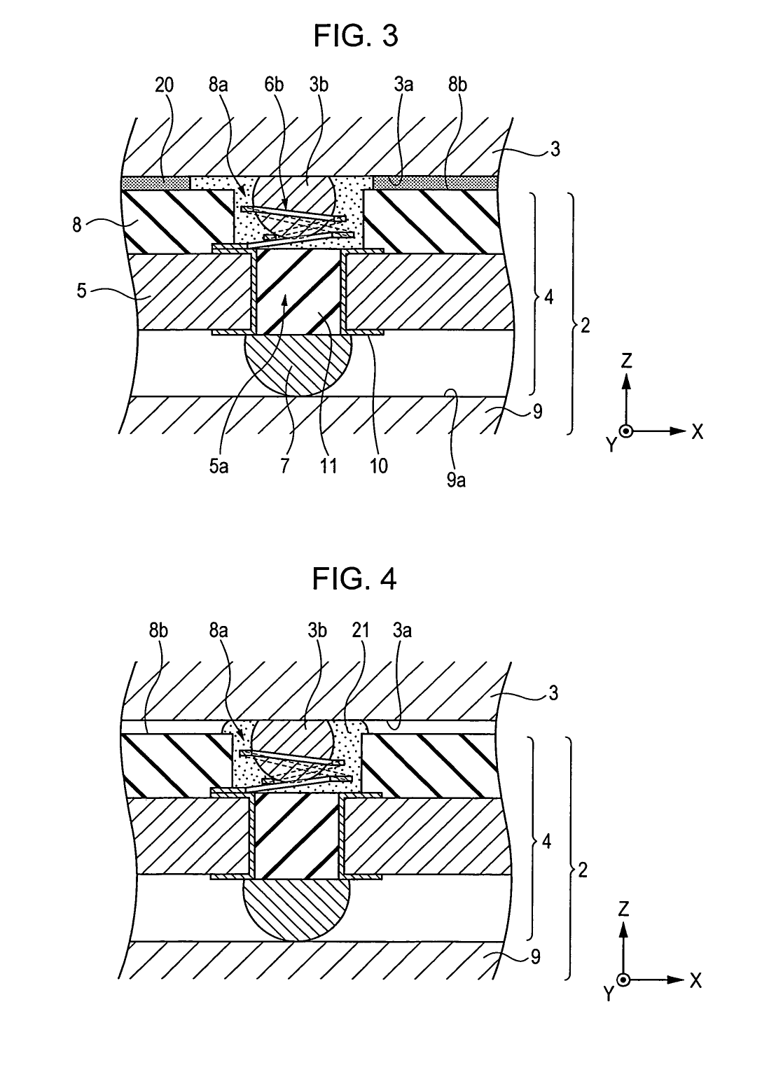

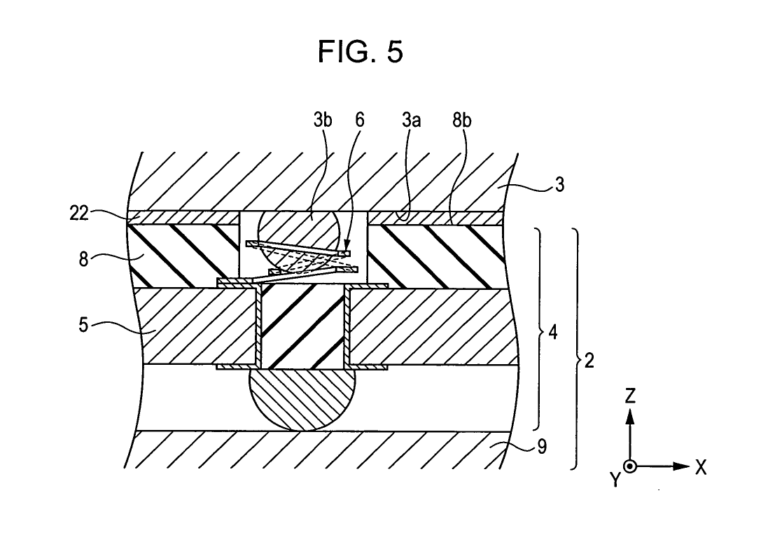

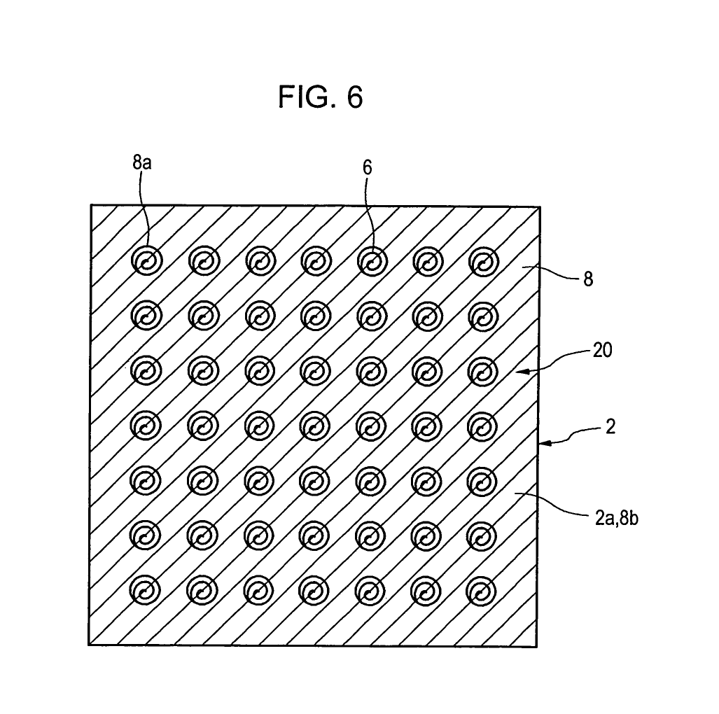

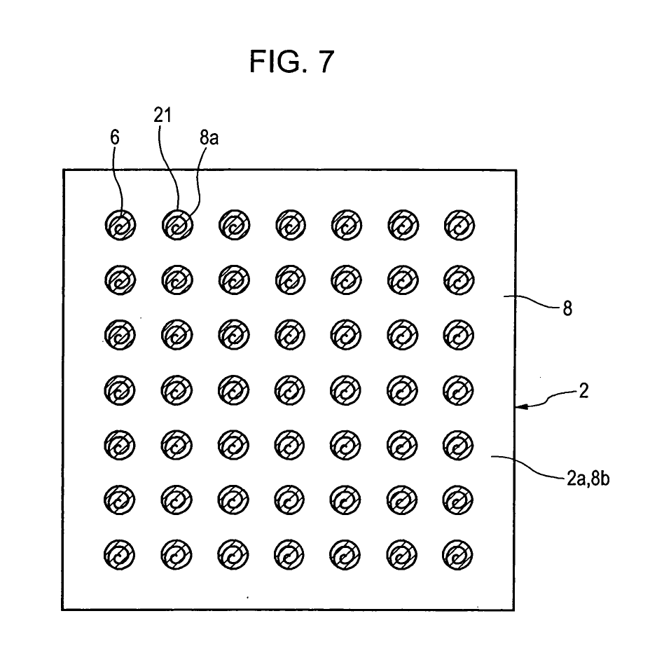

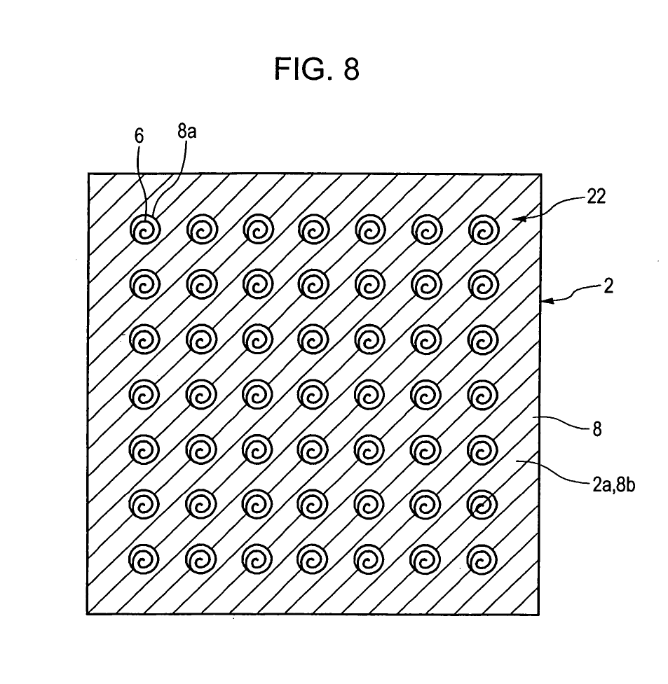

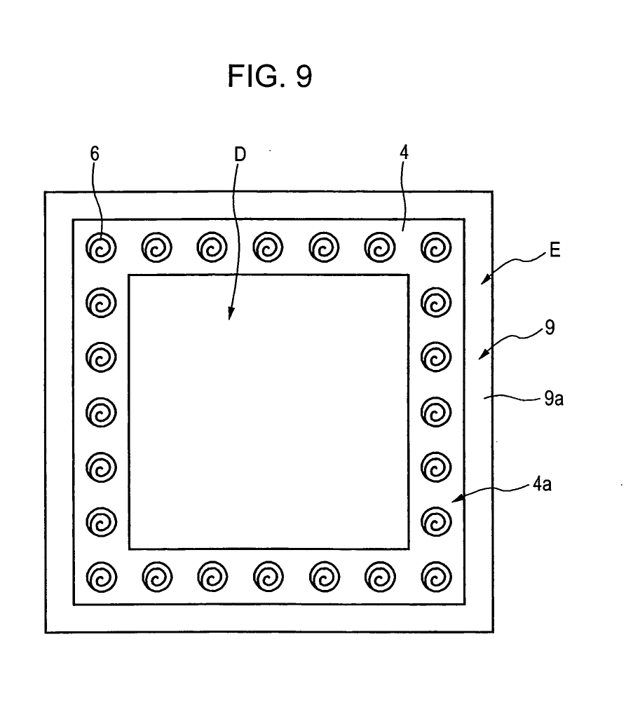

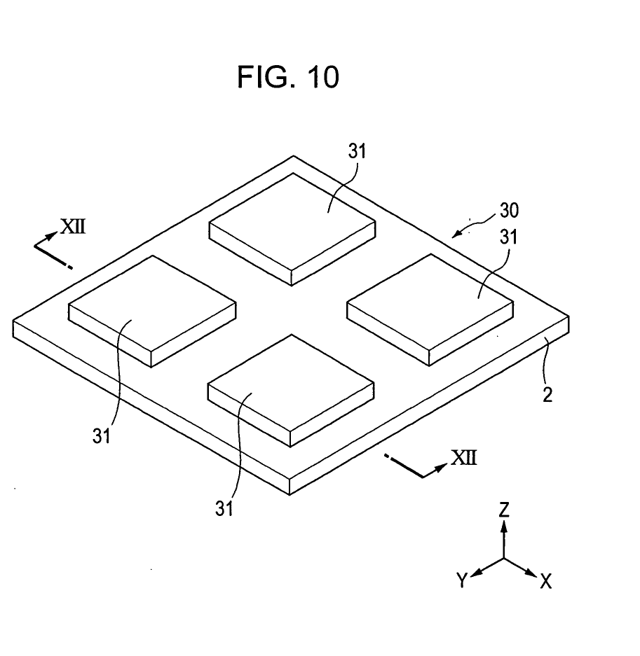

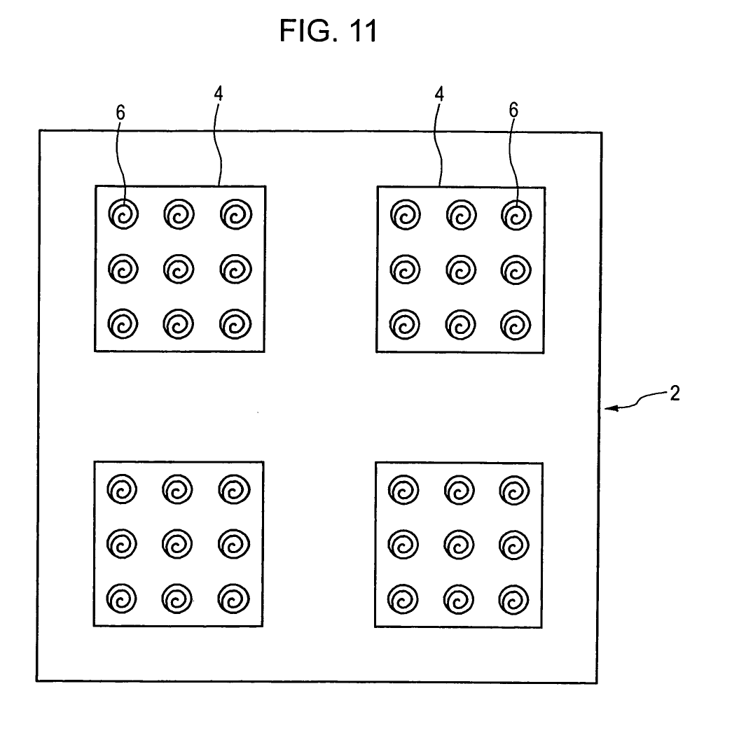

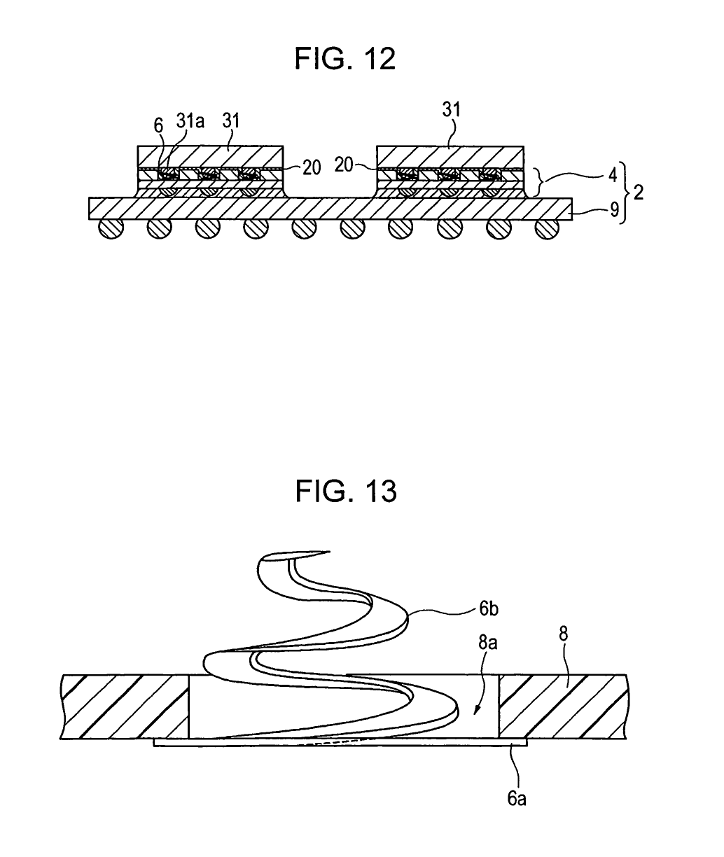

FIG. 1 is a perspective view of an electronic module (electronic function part mounted body) according to a first embodiment of the present invention, FIG. 2 is a partially sectional view of the electronic module taken along the line II-II shown in FIG. 1 in a direction parallel to the Z direction (thickness direction) and viewed from the direction indicated by arrows, FIG. 3 is a partially enlarged cross-sectional view of the electronic module showing an enlargement of the circled B region in FIG. 2, FIG. 4 is a partially enlarged cross-sectional view of an electronic module for explaining a structure different from the structure shown in FIG. 3, FIG. 5 is a partially enlarged cross-sectional view of an electronic module for explaining a structure different from the structure shown in FIG. 3 or 4, FIG. 6 is a partial plan view showing a surface of a substrate for particularly explaining an adhesion region according to the embodiment of FIG. 3, FIG. 7 is a partial plan view showing a surface of a substrate for particularly explaining an adhesion region according to the embodiment of FIG. 4, FIG. 8 is a partial plan view showing a surface of a substrate for particularly explaining an adhesion region according to the embodiment of FIG. 5, FIG. 9 is a partial plan view showing a surface of a substrate for explaining an embodiment different from that shown in FIG. 6 or FIG. 8, FIG. 10 is a perspective view showing a multi-tip module (electronic function part mounted body) according to a second embodiment of the present invention, FIG. 11 is a partial plan view showing a surface of the substrate which appears under the electronic function part according to the embodiment of FIG. 10, FIG. 12 is a partially sectional view of the multi-tip module taken along the line XII-XII shown in FIG. 10 in a direction parallel to the Z direction (thickness direction) and viewed from the direction indicated by arrows, and FIG. 13 is an enlarged side view for particularly explaining the overall structure of a spiral contactor.

In the drawings, the Z direction denotes the thickness direction or height direction, the X direction denotes the width direction, and the Y direction denotes the length direction. Each direction is orthogonal to the other two directions.

An electronic module 1 shown in FIG. 1 includes a substrate 2 and an electronic function part 3. The electronic function part 3 is, for example, an IC package or a bare chip having one or a plurality of memories such as a CPU, a MPU, a ROM, or a RAM.

The substrate 2 includes a base 9 and a contact member (relay member) 4. The base member 9 is composed of a number of stacked printed wiring boards (PWBs).

In an embodiment shown in FIG. 1 and FIG. 2, all of each plane shape of the base 9, the relay member 4, and the electronic function part 3 (the same shape as shown X-Y plane) is formed in the same rectangular shape and of the same size.

As shown in FIG. 2, on the under surface of the electronic function part 3 (the surface opposite to the substrate 2) 3a, a number of electrode portions 3b are provided. The electrode portions 3b may be spherical contactors (BGA) as shown in FIG. 2, or plane contactors (LGA), cone-shaped contactors (CGA), or pin-shaped contactors (PGA) which are not shown.

As shown in FIG. 2, on the under surface 9b of the base 9, external contactors 9c for connecting with external electrodes (for example, electrodes of a mother board) are provided. As the external contactors 9c, for example, spherical contactors (BGA) as shown in FIG. 2, plane contactors (LGA), cone-shaped contactors (CGA), or pin-shaped contactors (PGA) which are not shown can be used.

On the top surface 9a of the base 9, the contact member (relay member) 4 is provided. Through the contact member 4, electrode portions which appear on a top surface 2a (not shown) of the substrate 2 and electrode portions 3b of the electronic function part 3 are electrically connected with each other.

As shown in FIG. 3, the relay member 4 includes an attaching member 5, a contactor 6, a contactor 7, and a sheet member 8. The contactor 6 provided on the attaching member 5 is a spiral contactor whose elastic deforming portion is formed in a spiral shape, and hereinafter, the contactor 6 is referred to as a spiral contactor 6. The spiral contactor 6 shown in FIG. 3 is elastically deformed by the pressure from the electrode portion 3b of the electronic function part 3. When no pressure is applied to the spiral contactor, that is, before the electronic function part 3 is mounted onto the substrate 2, the spiral contactor 6 takes the shape as shown in FIG. 13. The spiral contactor 6 has a fixed portion 6a and an elastic deforming portion 6b which is extendedly formed from the fixed portion 6a. If the fixed portion 6a is viewed from the top, for example, it is formed in a ring-shape, and the elastic deforming portion 6b is formed so that the elastic deforming portion 6b extends from a predetermined point of the fixed portion 6a in an inward direction of the fixed portion 6a in a spiral shape. The elastic deforming portion 6b is formed so as to protrude in a top direction by means of three-dimensional forming as shown in FIG. 13. The fixed portion 6a is fixed and held by the sheet member 8. The sheet member 8 is preferably being formed of an insulating material, for example, polyimide resin. In the sheet member 8, a through hole 8a is provided and the fixed portion 6a is attached to around the under surface of the through hole 8a. Through the through hole 8a, the elastic deforming portion 6b of the spiral contactor 6 protrudes in the upward direction.

The spiral contactor 6 is formed by electroforming or plating on a foil surface. For example, the spiral contactor 6 can be formed by electroless plating with Ni or NiP around copper foil in the shape of spiral contactor.

As shown in FIG. 2, a number of the spiral contactors 6 are provided and each spiral contactor 6 is fixed to the sheet member 8 and held.

As shown in FIG. 3, in the attaching member 5, a through hole 5a is formed at an area opposite to the elastic deforming portion 6b of the spiral contactor 6 in a film thickness direction (shown Z direction). A conductive layer 10 is formed by sputtering etc. on the inner circumference of the through hole 5a, and the internal portion of the through hole 5a is filled with an insulating material layer 11. The conductive layer 10 is formed so as to extend to a part of the top surface of the attaching member 5 and the under surface of the attaching member 5. As shown in FIG. 3, the sheet member 8 to which the spiral contactor 6 is fixed and held is adhered to the top surface of the attaching member 5 with a conductive adhesive etc. (not shown). Then, the fixed portion 6a of the spiral contactor 6 is electrically connected with the conductive layer 10 through the conductive adhesive.

As shown in FIG. 3, on the under surface of the attaching member 5, a BGA-shaped under side contactor 7 is formed. The under side contactor 7 is electrically connected to the conductive layer 10, and the spiral contactor 6 and the under side contactor 7 are electrically connected with each other through the conductive layer 10. Also, the under side contactor 7 is electrically connected to an electrode portion (not shown) which is on the top surface 9a of the base 9. The under side contactor 7 may be a plane contactor (LGA), a cone-shaped contactor (CGA), a pin-shaped contactor (PGA), or a spiral contactor. If the contactor 7 is formed as the spiral contactor, the spiral contactor is fixed to a sheet member having the same characteristics as the sheet member 8 and held, the sheet member is adhered to the under surface of the attaching member 5 through a conductive adhesive or the like. The elastic deforming portion of the spiral contactor provided on the under surface of the attaching member 5 is, different from FIG. 13, substantially formed in a downward direction and the elastic deforming portion of the spiral contactor is electrically connected to the electrode portion disposed on the top surface 9a of the base 9. The relay member 4 and the base 9 are connected with, for example, an anisotropic conductive paste (ACP) (not shown). As the adhesive, as will be described below, a nonconductive paste (NCP) or a nonconductive film (NCF) can be used. The nonconductive paste (NCP) or the nonconductive film (NCF) is used between the under surface of attaching portion 5 and the top surface 9a of the base 9 except for the portion where the under side conductor 7 is to be formed so as to adhere the relay member 4 and the base 9 and fix them together. By means of the adhesion, the electrical connection between the under side conductor 7 and the electrode portion disposed on the top surface 9a of the base 9 can be retained. Further, the under side contactor may be a solder bump, and the under side contactor 7 and the electrode portion of the base 9 can be solder bonded.

FIG. 6 shows a top face 2a of the substrate 2. The top surface 2a of the substrate 2 is disposed opposite to the electronic function part 3. The top surface 8b of the sheet member 8 which composes the relay member 4 is disposed on the top surface 2a of the substrate 2. Diagonal lines shown in FIG. 6 denote an adhesion region of an adhesive which is placed between the substrate 2 and the electronic function part 3. As shown in FIG. 6, an anisotropic conductive paste 20 is applied to on the entire area of the top surface 8b of the sheet member 8. Further, the anisotropic conductive paste 20 is filled in the inside of the through hole 8a provided in the sheet member 8.

As shown in FIG. 3, the elastic deforming portion 6b of the spiral contactor 6 is elastically deformed by the pressure from the electrode portion 3b of the electronic function part mounted body 3, which ensures the contacting state between the elastic deforming portion 6b and the electrode portion 3b. In this state, as shown in FIG. 2 and FIG. 3, an under surface 3a of the electronic function part 3 (the opposite surface to the substrate 2) and the top surface 2a of the substrate 2 are adhered with the anisotropic conductive paste 20 and fixed together. By adhering the under surface 3a of the electronic function part 3 and the top surface 2a of the substrate 2 with the anisotropic conductive paste 20 and fixing them together, it is possible to ensure fixation between the electronic function part 3 and the substrate 2, with the electrode portion 3b of the electronic function part 3 and the spiral contactor 6 having adequately electrically conduction.

The elastic deforming portion 6b of the spiral contactor 6 is readily elastically deformed by the pressure from the electrode portion 3b of the electronic function part 3, and that ensures the electrical connection between the spiral contactor 6 and the electrode portion 3b. Particularly, the elastic deforming portion 6b is preferable since the elastic deforming portion 6b is formed in a spiral shape, even if the electrode portion 3b of the electronic function part 3 takes any shape, the elastic deforming portion 6b can be deformed so as to surround the periphery of the electrode portion 3b, and enables contact with the electrode portion 3b to be ensured. Further, since the contact pressure from the elastic deforming portion 6b generated when the electrode portion 3b of the electronic function part 3 downwardly presses the elastic deforming portion 6b of the spiral contactor 6 is small, it is possible to adhere the substrate 2 and the electronic function part 3 and fix them together while retaining the state that the elastic deforming portion 6b and the electrode portion 3b are securely contacted with each other.

In FIG. 3 and FIG. 6, the anisotropic conductive paste 20 is used to fill the entire area between the under surface 3a of the electronic function part 3 and the top surface 2a of the substrate 2, however, an anisotropic conductive paste 21 can be used to fill a part of the entire area between the under surface 3a of the electronic function part 3 and the top surface 2a of the substrate 2. In this case, at least as shown in FIG. 4 and FIG. 7, it is preferable to use the anisotropic conductive paste 21 to fill the inside of the through hole 8a provided in the sheet member 8 so as to adhere between the substrate 2 and the electronic function part 3 and fix them together. As described above, the anisotropic conductive paste 21 is partially used to fill the inside of the through hole 8a provided in the sheet member 8 without applying the anisotropic conductive paste 21 to the entire area of the top surface 2a of the substrate 2.

By using the anisotropic conductive paste 21 to fill the inside of the through hole 8a, the substrate 2 and the electronic function part 3 are adhered and fixed together while the elastic deforming portion 6b of the spiral contactor 6 which is exposed from the through hole 8a and the electrode portion 3b of the electronic function part 3 are adequately electrically connected to each other. As shown in FIG. 4, if the electrode portion 3b of the electronic function part 3 enters into the inside of the through hole Ba, the anisotropic conductive paste 21 which fills the inside of the through hole 8a pushes the elastic deforming portion 6b of the spiral contactor 6 which is exposed from the through hole 8a and three-dimensionally formed in the direction toward the base 9 (downward direction in the drawing), and the elastic deforming portion 6b is elastically deformed. This ensures that the elastic deforming portion 6b and the electrode portion 3b contact with each other. While a part of the anisotropic conductive paste 21 which fills the inside of the through hole 8a is pushed out in the upward direction from the inside of the through hole 8a and reaches to not only the periphery of the electrode portion 3b but also the under surface 3a of the electronic function part 3. Further, the part of the anisotropic conductive paste 21 penetrates from the through hole 8a into the space between the under surface 3a of the electronic function part 3 and the top surface 8b, and lies between the under surface 3a of the electronic function part 3 and the top surface 8b of the sheet member 8. As described above, since the anisotropic conductive paste 21 is likely to extend not only between the electrode portion 3b and the spiral contactor 6 but also to the under surface 3a of the electronic function part 3, it is possible to strengthen the adhesion between the substrate 2 and the electronic function part 3. Thus, if the region where the electrode portion 3b and the elastic deforming portion 6b of the spiral contactor 6 are in contact with each other is formed to be surrounded by the concave-shaped region (forming the through hole 8a), and has the structure such that the anisotropic conductive paste 21 is used to fill the inside of the concave region, even if the anisotropic conductive paste 21 is used to partially fill the concave region, it is possible to strengthen the adhesion between the substrate 2 and the electronic function part 3.

In FIG. 5 and FIG. 8, as an adhesive for adhering the substrate 2 and the electronic function part 3 together, a nonconductive paste (NCP) 22 is used. As shown in FIG. 8, the nonconductive paste 22 is not applied to the entire area of the top surface 2a of the substrate 2, that is, the nonconductive paste 22 is not applied to the inside of the through hole 8a which is formed in the sheet member 8. It is not preferable to apply the nonconductive paste 22 to the inside of the through hole 8a since if the inside of the through hole 8a is filled with the nonconductive paste 22, the electrical connection between the elastic deforming portion 6b of the spiral contactor 6 and the electrode portion 3b of the electronic function part 3 decreases, and that is apt to cause failure in electrical connection.

By placing the nonconductive paste 22 between the top surface 8b of the sheet member 8 except for the portion where the through hole 8a is formed and the under surface 3a of the electronic function part 3, it is possible to ensure that the substrate 2 and the electronic function part 3 are adhered and fixed together while the electrical connection between the elastic deforming portion 6b of the spiral contactor 6 and the electrode portion 3b is adequately retained. As an alternative to the nonconductive paste 22, a nonconductive film can be used.

As shown in embodiments in FIG. 5 and FIG. 8, if the tall sheet member 8 is provided so as to surround the periphery of the spiral contactor 6 which is three-dimensionally formed and the top surface 8b of the sheet member 8 and the under surface 3a of the electronic function part 3 are adhered with the nonconductive paste 22, compared with the case in which the sheet member 8 does not exist, it is possible to strengthen the adhesion and fixation between the substrate 2 and the electronic function part 3. Considering the case in which the sheet member 8 does not exist, if the sheet member 8 does not exist, the top surface of the attaching member 5 where the spiral contactor 6 is to be provided and the under surface 3a of the electronic function part 3 are adhered and fixed together by placing the nonconductive paste 22 between them. However, the elastic deforming portion 6b of the spiral contactor 6 is three-dimensionally formed in the upward direction, and considering the thickness of the electrode portion 3b etc., if adhering the substrate 2 and the electronic function part 3 and fixing them together, a large space exists between the under surface 3a of the electronic function part 3 and the top surface of the attaching member 5, and it is necessary to consider the applying amount of the nonconductive paste 22 etc. in order to adequately fill the space. Therefore, if the applying amount of the nonconductive paste 22 is small, the adhered portion between the substrate 2 and the electronic function part 3 is apt to be damaged when the adhesion between the substrate 2 and the electronic function part 3 weakens and the electronic module 1 is exposed to an impact. On the other hand, as shown in FIG. 5 and FIG. 8, by providing the sheet member 8 having the through hole 8a, attaching the sheet member 8 on the top surface of the attaching member 5 where the spiral contactor 6 is to be attached, and exposing the elastic deforming portion 6b of the spiral contactor 6 in the upward direction, it is possible to reduce the space between the top surface 8b of the sheet member 8 and the under surface 3a of the electronic function part 3 without inhibiting the contact between the electrode portion 3b and the spiral contactor 6 compared with the case in which the sheet member 8 is not provided. Accordingly, the adequate adhesion and fixation between the electronic function part 3 and the substrate 2 can be achieved even if the amount of the nonconductive paste 22 is small. In particular, by decreasing the applying amount of the nonconductive paste 22, at the adhesion step, if the electronic function part 3 is pressed against the side of the substrate 2, a negligible amount of the nonconductive paste 22 runs over into the inside of the through hole 8b, and the electrical connection between the elastic deforming portion 6b of the spiral contactor 6 and the electrode portion 3b can be well retained.

In an embodiment shown in FIG. 9, the relay member 4 which is provided on the top surface 9a of the base 9 is not the same in size as the top surface 9a, for example, as shown in FIG. 9, it may be rectangular-ring shaped. In FIG. 9, the entire area of the top surface 9a of the base 9 is not covered with the relay member 4, but a part of the top surface 9a of the base 9 is exposed. Then, the region for adhering the substrate 2 and the electronic function part 3 is not limited to the top surface 4a of the relay member 4, the exposed portion of the top surface 9a of the base 9 can be used as the adhesion region. Further, only the exposed portion of the top surface 9a of the base 9 can be used as the adhesion region. Then, an adhesive may be partially applied to the top surface 9a. For example, from a central region D of the inner circumference of the relay member 4, the top surface 9a of the base 9 is exposed, and only the central region D can be used for the adhesion region, or the top surface 4a of the relay member 4 may be used in addition to the central region D as the adhesion region. As a matter of course, an outer region E where is the outer circumference of the relay member 4 and the top surface 9a of the base 9 is exposed can be used as the adhesion region. Also, as a matter of course, the entire area of the top surface 2a of the substrate 2 including the central region D, the outer region E, and the top surface 4a of the relay member 4 can be used as the adhesion region.

As to the types of adhesives used on the central region D or the outer region E, if there is no electrode which electrically connects the electronic function part 3 and the substrate 2 in the central region D or the outer region E, nonconductive pastes or nonconductive films can be provided on the entire area or partial area of the central region D or the outer region E. If there is an electrode or the like in the central region D or the outer region E, on the region except for the portion where the electrode or the like exists, the nonconductive pastes or the nonconductive films may be provided. Further, whether an electrode or the like exists or not, anisotropic conductive pastes may be used.

As described above, in the embodiment, the substrate 2 and the electronic function part 3 can be securely adhered and fixed together while the elastic deforming portion 6b of the spiral contactor 6 and the electrode portion 3b of the electronic function part 3 are adequately electrically connected. Thus, in the present embodiment, between the substrate 2 and the electronic function part 3, it is not necessary to newly provide a holding member or the like used to tightly fix and hold the substrate 2 and the electronic function part 3. Accordingly, the downsizing of the electronic module 1 can be achieved.

Further, in the present embodiment, since the spiral contactor 6 is provided for the connection of the electrode portion 3b of the electronic function part 3, for example, if the electronic module 1 is exposed to an impact, the spiral contactor 6 can absorb the shock, and it is possible to tightly adhere the substrate 2 and the electronic function part 3 and fix together. Therefore, the electronic module 1 is resistant to damage caused by external force being applied thereto.

FIG. 10 is a perspective view showing a multi-tip module 30. As shown in FIG. 10 or FIG. 12, on the substrate 2 having the base 9 and the relay member 4, a plurality of electronic function parts 31 having such as a bare chip or an IC package are attached.

FIG. 11 is a plan view showing the substrate 2 before the plurality of electronic function parts 31 are attached to the substrate 2. On each region corresponding to the setting portion of each electronic function part 31, the relay member 4 is provided and on each relay member 4, a plurality of spiral contactors 6 are provided. As to the structure of the relay member 4, the structure is the same as described in the description of FIG. 3 or FIG. 13. As shown in FIG. 12, between the electrode portion 31a of the electronic function part 31 and the substrate 2, the anisotropic conductive paste 20 is placed as well as shown in FIG. 3, and by the anisotropic conductive paste 20, the electronic function part 31 and the substrate 2 are adhered and fixed together. As described above, the present invention can be applied to the multi-tip module 30 shown in FIG. 10 to FIG. 12. Thus, the substrate 2 and the electronic function part 31 can be securely adhered and fixed together while the elastic deforming portion 6b of the spiral contactor 6 and the electrode portion 31a of the electronic function part 31 are adequately electrically connected. Accordingly, the multi-tip module 30 can be downsized and further, the multi-tip module 30 is impact resistant.

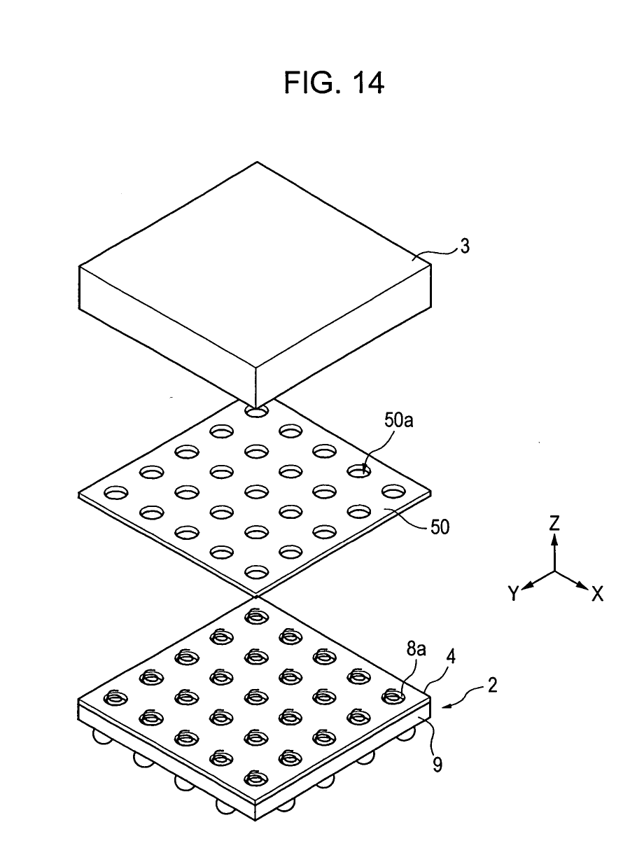

Now, a manufacturing method of the electronic module 1 shown in FIG. 1 will be described. First, a case in which the substrate 2 and the electronic function part 3 are adhered with the nonconductive film (NCF) will be described. As shown in FIG. 14, the substrate 2 having the base 9 and the relay member 4, the electronic function part 3, and the nonconductive film 50 are prepared. On the nonconductive film 50, a plurality of through holes 50a are formed. The through holes 50a are provided on the same areas as the through holes 8a formed in the sheet member 8 and formed in the same size as the through holes 8a or rather larger in size than the through holes 8a. The nonconductive film 50 is placed between the substrate 2 and the electronic function part 3, and the top surface of the electronic function part 3 is pressed in the direction to the substrate 2 (the downward direction in the drawing). Then, as shown in FIG. 5, the electrode portion 3b of the electronic function part 3 enters into the inside of the through hole Ba formed in the sheet member 8. In the through hole 8a, the elastic deforming portion 6 b of the spiral contactor 6 is pushed and elastically deformed, and the elastic deforming portion 6b and the electrode portion 3b are adequately contacted with each other. While retaining the state (that is, retaining the state that the top surface of the electronic function part 3 is pressed in the direction to the substrate 2), a heating process is performed, and the nonconductive film 50 is hot-cured. Thus, the substrate 2 and the electronic function part 3 can be tightly adhered and fixed together.

According to the above-described manufacturing method, the substrate 2 and the electronic function part 3 can be adequately adhered and fixed together while the elastic deforming portion 6b of the spiral contactor 6 and the electrode portion 3b of the electronic function part 3 are adequately electrically connected with each other.

If the anisotropic conductive paste 20 is used as shown in FIG. 3, the anisotropic conductive paste 20 is applied to on the entire area of the sheet member including the through hole 8a, and in the case shown in FIG. 4, the anisotropic conductive paste 21 is filled in at least the inside of the through hole 8a, then, as described above, the top surface of the electronic function part 3 is pressed in the direction to the substrate 2. While retaining the state, the heating process may be performed and the anisotropic conductive paste 20 or the anisotropic conductive paste 21 may be hot-cured. If the nonconductive paste 22 is used, the nonconductive paste 22 is applied to on the sheet member 8 except for the through hole 8a, then, as described above, while retaining the state that the top surface of the electronic function part 3 is pressed in the direction to the substrate 2, the heating process is performed and the nonconductive paste 22 may be hot-cured.

Before conducting the heating process, a predetermined electrical characteristics inspection can be performed and only when the predetermined electrical characteristics are obtained, then, the heating step may be performed. That is, if the predetermined electrical characteristics are not obtained, the electronic function part 3 which is determined to be defective is replaced with a new electronic function part 3 or the like, and the electrical characteristics inspection may be performed again. If the electrical characteristics inspection is conducted after the heating process is performed and the substrate 2 and the electronic function part 3 are adhered, and fixed together, in a case in which the predetermined electrical characteristics are not obtained, the electronic module 1 itself has to be discarded even if the substrate 2 is normal. Therefore, the method of conducting the electrical characteristics inspection after heating, adhering the substrate 2 and the electronic function part 3 and fixing them together cannot adequately increase productivity.

In the present embodiment, the electrical characteristics inspection is performed in the state that the nonconductive paste or the nonconductive film is placed between the electronic function part 3 and the substrate 2 (at the time, the heating process is not performed). If the predetermined electrical characteristics are not obtained, for example, the electronic function part 3 is replaced with a new electronic function part 3 or the like, and the electrical characteristics inspection may be performed again. If the heating process is performed only when the predetermined electrical characteristics are obtained, the number of parts which are to be discarded can be decreased and the productivity can be increased.

Further, it may also be possible to bring the electronic function part 3 in contact with the substrate 2 without placing the nonconductive paste or the nonconductive film between the electronic function part 3 and the substrate 2, and only when the predetermined electrical characteristics are obtained, place the anisotropic conductive paste, the nonconductive paste, or the nonconductive film between the electronic function part 3 and the substrate 2, then, perform the heating process at once so as to adhere the electronic function part 3 and the substrate 2 and fix them together. If the adhesive is placed between the electronic function part 3 and the substrate 2, even if the heating process is not performed, there is a possibility that a large amount of the adhesive is adhered to the electronic function part 3 side when removing the electronic function part 3 which is determined to be defective from the substrate 2. In this case, another applying step of the adhesive is required, and in some case, it may be difficult to remove the electronic function part 3 due to the adhesion of the adhesive. Accordingly, it can be considered that the method includes placing the anisotropic conductive paste, the nonconductive paste, or the nonconductive film between the electronic function part 3 and the substrate 2, and performing the heating process step after the inspection. In the present invention, since the spiral contactor 6 which acts as an elastic contact point is used as a contact point of the electrode portion 3b of the electronic function part 3, in the state that the top surface of the electronic function part 3 is pressed in the direction to the substrate 2, the elastic deforming portion 6b of the spiral contactor 6 and the electrode portion 3b are securely contacted with each other, and good electrical connection can be retained. Accordingly, even if the electronic function part 3 and the substrate 2 are not adhered for a time with the anisotropic conductive paste, the nonconductive paste, or the nonconductive film, the electrical characteristics inspection can be adequately conducted.

Further, if the electronic function part 3 and the substrate 2 are adhered and fixed together by placing the anisotropic conductive paste, the nonconductive paste, or the nonconductive film, and then, performing the heating process, a metal-to-metal connection is apt to be generated at a boundary face of the electrode portion 3b of the electronic function part 3 which is being connected with the elastic contact point and retained.

Further, if the anisotropic conductive paste, the nonconductive paste, or the nonconductive film is placed between the electronic function part 3 and the substrate 2, and the electrical characteristics inspection is conducted before the heating process is performed, it is preferable to place the nonconductive paste or the nonconductive film. If the nonconductive paste or the nonconductive film is used, the inside of the through hole 8a formed in the sheet member is not filled with the nonconductive paste or the nonconductive film. Accordingly, if the electrical characteristics inspection is determined to have failed and the electronic function part 3 is removed from the substrate 2, the viscous adhesive does not attach to the spiral contactor 6, and therefore, it can be possible to prevent the spiral contactor 6 from damage when removing the electronic function part 3 from the substrate 2. As described above, it is preferable that before performing the heating process, the electrical characteristics inspection is conducted while the adhesive is placed between the substrate 2 and the electronic function part 3, then, if the heating process is performed, the nonconductive paste or the nonconductive film is placed between the substrate 2 and the electronic function part 3.

Further, it is considered that the side of the substrate 2 is determined as defective by the electrical characteristics inspection. In this case, the substrate 2 is replaced with a new substrate 2, and the electrical characteristics inspection is conducted again. Then, it is possible to replace only the relay member 4 or the base 9. That is, between the relay member 4 and the base 9, the anisotropic conductive paste, the nonconductive paste, or the nonconductive film is placed, and after the electrical characteristics inspection is completed, if the adhesive is heat-cured at the same step as the heating step to the adhesive placed between the electronic function part 3 and the substrate 2, it is possible to replace only the relay member 4 with the new relay member 4.

The structure of the present invention can be applied to the electronic module 1 shown in FIG. 1 and the multi-tip module 30 shown in FIG. 10 which are mounted on a mother board. That is, it can be possible to provide a relay member having a spiral contactor on a mother board, place the anisotropic conductive paste, the nonconductive paste, or the nonconductive film between the external contactor 9c of the electronic module 1 and the relay member, adhere the electronic module 1 onto the mother board 1 and fix them together. Further, the structure of the present invention can be applied to when mounting an IC package or the like (electronic function part) which is manufactured by a different structure from the structure shown in FIG. 1, on the mother board.

Further, in the above description, the applying region of the anisotropic conductive paste is the entire area of the top surface 2a of the substrate 2 or at least the inside of the through hole 8a formed in the sheet member 8. However, as well as the nonconductive paste and the nonconductive film, the anisotropic conductive paste can be applied to at least a part of the top surface 2a of the substrate 2 except for the through hole 8a.

What is claimed is:

1. A electronic function part mounted body comprising:
an electronic function part; and
a substrate for mounting the electronic function part;
wherein an electrode portion is provided on a surface of the electronic function part opposite to the substrate and an elastic contact point is provided on a surface of the substrate opposite to the electronic function part, and
the electronic function part and the substrate are adhered with a conductive or nonconductive adhesive and fixed together with the electrode portion and the elastic contact point contacting each other.

2. The electronic function part mounted body according to claim 1, wherein at least the electrode portion and the elastic contact point are adhered with an anisotropic conductive paste and fixed together.

3. The electronic function part mounted body according to claim 2, wherein the substrate includes a base and a contact member having the elastic contact point and a sheet member, the contact member is connected to the base, a through hole is formed in the sheet member, the elastic contact point is exposed from the through hole, the through hole is filled with the anisotropic conductive paste, and the electrode portion and the elastic contact point are adhered and fixed together.

4. The electronic function part mounted body according to claim 2, wherein the entire area of the opposite surface of the electronic function part is adhered onto the opposite surface of the substrate with the anisotropic conductive paste and fixed together.

5. The electronic function part mounted body according to claim 1, wherein at least a part of the opposite surface of the electronic function part and the opposite surface of the substrate except for an area where the electrode portion and the elastic contact point are to be formed are adhered with a nonconductive paste and fixed together.

6. The electronic function part mounted body according to claim 1, wherein at least a part of the opposite surface of the electronic function part and the opposite surface of the substrate except for an area where the electrode portion and the elastic contact point are to be formed are adhered with a nonconductive film and fixed together.

7. The electronic function part mounted body according to claim 5, wherein the substrate includes a base and a contact member having the elastic contact point and a sheet member, the contact member is connected to the base, a through hole is formed in the sheet member, the elastic contact point is exposed from the through hole, and the nonconductive paste is provided between the sheet member except for the area where the through hole is to be formed and the opposite surface of the electronic function part.

8. The electronic function part mounted body according to claim 6, wherein the substrate includes a base and a contact member having the elastic contact point and a sheet member, the contact member is connected to the base, a through hole is formed in the sheet member, the elastic contact point is exposed from the through hole, and the nonconductive film is provided between the sheet member except for the area where the through hole is to be formed and the opposite surface of the electronic function part.

9. The electronic function part mounted body according to claim 1, wherein the elastic contact point comprises a spiral contactor.

10. A method of manufacturing an electronic function part mounted body, the electronic function part mounted body comprising an electronic function part and a substrate for mounting the electronic function part, an electrode portion being provided on a surface of the electronic function part opposite to the substrate and an elastic contact point being provided on a surface of the substrate opposite to the electronic function part;
wherein the electronic function part and the substrate are adhered with a conductive or nonconductive adhesive and fixed together with the electrode portion and the elastic contact point contacting each other.

11. The method of manufacturing the electronic function part mounted body according to claim 11, wherein at least the electrode portion and the elastic contact point are adhered with an anisotropic conductive paste and fixed together.

12. The method of manufacturing the electronic function part mounted body according to claim 11, wherein the substrate includes a base and a contact member having the elastic contact point and a sheet member, the contact member is connected to the base, a through hole is formed in the sheet member, the elastic contact point is exposed from the through hole, the through hole is filled with the anisotropic conductive paste, the electrode portion and the elastic contact point are adhered and fixed together.

13. The method of manufacturing the electronic function part mounted body according to claim 10, wherein the entire area of the opposite surface of the electronic function part is adhered onto the opposite surface of the substrate with the anisotropic conductive paste and fixed together.

14. The method of manufacturing the electronic function part mounted body according to claim 10, wherein at least a part of the opposite surface of the electronic function part and a part of the opposite surface of the substrate except for the area where the electrode portion and the elastic contact point are to be formed are adhered with nonconductive paste and fixed together.

15. The method of manufacturing the electronic function part mounted body according to claim 10, wherein at least a part of the opposite surface of the electronic function part and a part of the opposite surface of the substrate except for the area where the electrode portion and the elastic contact point are to be formed are adhered with nonconductive film and fixed together.

16. The method of manufacturing the electronic function part mounted body according to claim 14, wherein the substrate includes a base and a contact member having the elastic contact point and a sheet member, the contact member is connected to the base, a through hole is formed in the sheet member, and the elastic contact point is exposed from the through hole, the nonconductive paste is provided between the sheet member except for the area where the through hole is to be formed and the opposite surface of the electronic function part, adhered and fixed together.

17. The method of manufacturing the electronic function part mounted body according to claim 15, wherein the substrate includes a base and a contact member having the elastic contact point and a sheet member, the contact member is connected to the base, a through hole is formed in the sheet member, and the elastic contact point is exposed from the through hole, the nonconductive film is provided between the sheet member except for the area where the through hole is to be formed and the opposite surface of the electronic function part, adhered and fixed together.

18. The method of manufacturing the electronic function part mounted body according to claim 10, wherein the conductive or nonconductive adhesive is placed between the electronic function part and the substrate, an inspection is conducted with the electrode portion and the elastic contact point are contacting each other, after the inspection is completed, the adhesive is cured by heating, the electronic function part and the substrate are adhered, and fixed together.

19. The method of manufacturing the electronic function part mounted body according to claim 18, wherein if the result of the inspection is acceptable, the heating is performed.

20. The method of manufacturing the electronic function part mounted body according to claim 18, wherein the electronic function part or the substrate which is determined to have failed by the inspection is replaced with a new electronic function part or substrate, and the inspection is conducted again.

21. The method of manufacturing the electronic function part mounted body according to claim 10, wherein an inspection is conducted without placing the conductive or nonconductive adhesive between the electronic function part and the substrate, with the electrode portion and the elastic contact point contacting each other, after the inspection is completed, the conductive or nonconductive adhesive is placed between the electronic function part and the substrate, the adhesive is cured by heating, the electronic function part and the substrate are adhered, and fixed together.

22. The method of manufacturing the electronic function part mounted body according to claim 20, wherein if the result of the inspection is acceptable, the conductive or nonconductive adhesive is placed between the electronic function part and the substrate, and the heating is performed.

23. The method of manufacturing the electronic function part mounted body according to claim 21, wherein the electronic function part or the substrate which is determined to have failed by the inspection is replaced with a new electronic function part or substrate, and the inspection is conducted again.
